(19) United States
(12) Patent Application Publication
(10) Pub. No.: US 2019/0355501 A1
(43) Pub. Date: Nov. 21, 2019

(54) Method for Manufacturing a Functionalized Magnetic Particle

(71) Applicant: Baden-Wuerttemberg Stiftung gGmbH, Stuttgart (DE)

(72) Inventors: Michael Schneider, Wuerzburg (DE); Karl-Sebastian Mandel, Guentersleben (DE); Carsten Gellermann, Gerbrunn (DE)

(21) Appl. No.: 15/982,110

(22) Filed: May 17, 2018

(51) Int. Cl. H01F 1/36; H01F 41/24; C02F 1/42

(52) U.S. Cl. CPC H01F 1/36; C02F 2001/422; C02F 1/42; H01F 41/24

(57) ABSTRACT

The present invention relates to a method for manufacturing a functionalized magnetic particle comprising the steps of: a) mixing an aqueous solution comprising a magnetic microparticle having a silica based surface with an aqueous solution of at least one metal salt to obtain a dispersion; and b) mixing the dispersion with a solution of sodium hydroxide, wherein the mixing is performed by simultaneously pumping the dispersion and the solution of sodium hydroxide through a static mixer, wherein the static mixer has a cylindrical design, a length of at least 320 mm and an inner diameter of at least 11 mm. The present invention further relates to a particle for recovering an anion from an aqueous solution obtainable by the method of the invention. The present invention further relates to various uses of the particle of the invention.

### FIELD OF THE INVENTION

The present invention relates to a method for manufacturing a functionalized magnetic particle comprising the steps of: a) mixing an aqueous solution comprising a magnetic microparticle having a silica based surface with an aqueous solution of at least one metal salt to obtain a dispersion, wherein each solution independently has a pH of about 6 to about 8; and b) mixing the dispersion with a solution of sodium hydroxide for precipitating the metal salt as metal hydroxide and/or metal oxide on the surface of the microparticle, thereby obtaining the functionalized magnetic particle, wherein the mixing is performed by simultaneously pumping the dispersion and the solution of sodium hydroxide through a static mixer, wherein the static mixer has a cylindrical design, a length of at least 320 mm and an inner diameter of at least 11 mm. The present invention further relates to a particle for recovering an anion from an aqueous solution obtainable by the method of the invention. The present invention further relates to various uses of the particle of the invention.

### BACKGROUND OF THE INVENTION

The increasing shortage of non-renewable raw materials, especially those of industrial importance, is a major concern world-wide. Non-renewable raw materials include for example phosphorus, in form of phosphate, one of the most important elements for life. Phosphate builds up the backbone of DNA and is part of the energy carrier adenosine triphosphate in every cell. Agriculture relies heavily on phosphate as fertilizer which is needed by every plant to grow. However, the main source of phosphorus, rock-phosphate, is a non-renewable resource. By a steadily increasing demand, natural deposits are continuously depleted, and will contain lower phosphate concentrations and a higher content of impurities such as heavy metals in the future. If such sources are used, the consequence is a contamination of soil and eventually nourishment containing heavy metals.

Potential ways of recycling raw materials such as phosphate are intensively investigated. Waste water plants show a continuous flow-through of phosphate arising from fertilisers, animal and human excrement, industry, but also from natural sources such as rocks. Without efficient separation techniques, phosphate is discharged into lakes and rivers where it contributes to the growth of algae and increased water eutrophication. Therefore, recovery of phosphate from waste water prevents loss of a scarce resource and protects natural waters from pollution.

For recovering phosphate from waste water, the use of magnetic particles having ion exchange materials immobilized on their surface (ion exchange particles) is investigated. Ion exchange materials that directly and specifically bind phosphate are known. Ion exchange particles can be applied to the waste water stream and, after a sufficient period of time for ion exchange, they can be removed by magnetic separation techniques.

Ion exchange particles are an example of functionalized magnetic particles. They are manufactured by precipitating the desired ion exchange materials onto magnetic carrier particles. This leads to stable ion exchange particles in laboratory scale. However, when upscaling the manufacturing process with a view to commercially producing large amounts of ion exchange particles, obtaining stable particles is challenging. It was observed that ion exchange particles, which are obtained by upscaling existing methods for their manufacture, show a very low stability. After only few days of storage, the ion exchange material detaches from the particles. The low stability of the ion exchange particles impedes their long-term storage and their re-use over many cycles of waste water treatment. It also leads to a loss of ion exchange material during their use since once detached from the magnetic particles, the ion exchange material will no longer be removed from the waste water during the magnetic separation step. As a consequence, it will be discharged into natural waters where it contributes to water pollution.

Therefore, a method for manufacturing functionalized magnetic particles that leads to stable functionalized particles and is suitable for large-scale manufacturing of the particles is needed.

### SUMMARY OF THE INVENTION

In a first aspect, the present invention relates to a method for manufacturing a functionalized magnetic particle, comprising the steps of:
a) mixing an aqueous solution comprising a magnetic microparticle having a silica based surface with an aqueous solution of at least one metal salt to obtain a dispersion, wherein each solution independently has a pH of about 6 to about 8; and
b) mixing the dispersion with a solution of sodium hydroxide for precipitating the metal salt as metal hydroxide and/or metal oxide on the surface of the microparticle, thereby obtaining the functionalized magnetic particle, wherein the mixing is performed by simultaneously pumping the dispersion and the solution of sodium hydroxide through a static mixer, wherein the static mixer has a cylindrical design, a length of at least 320 mm and an inner diameter of at least 11 mm.

In a second aspect, the present invention relates to a particle for recovering an anion from an aqueous solution obtainable by the method of the invention.

In a third aspect, the present invention relates to the use of the particle of the invention for recovering an anion, preferably a phosphate anion, from an aqueous solution.

In a further aspect, the present invention relates to the use of the particle of the invention for catalysing a chemical reaction by heterogeneous catalysis.

In a further aspect, the present invention relates to the use of the particle of the invention as a carrier for a biochemical molecule, preferably an enzyme, immobilized on the metal hydroxide and/or metal oxide.

### BRIEF DESCRIPTION OF THE FIGURES

FIG. 1 shows the time course of pH (FIG. 1a) and electrical conductivity (FIG. 1b) of samples A) to D) during a monitoring period. The samples are supernatants of functionalized particles which were obtained by different manufacturing methods. During the monitoring period, the functionalized particles were stored in deionized water.

FIG. 2 shows the time course of concentrations of dissolved metal ions and dissolved silicon ions in samples A) to D) during the monitoring period. FIG. 2a shows the results for sample A). FIGS. 2b to 2d show the results for samples B) to D), respectively. FIG. 2e shows the results for sample D) with an enlarged y-axis.

### DETAILED DESCRIPTION OF THE INVENTION

In a first aspect, the present invention relates to a method for manufacturing a functionalized magnetic particle, comprising the steps of:
a) mixing an aqueous solution comprising a magnetic microparticle having a silica based surface with an aqueous solution of at least one metal salt to obtain a dispersion, wherein each solution independently has a pH of about 6 to about 8; and
b) mixing the dispersion with a solution of sodium hydroxide for precipitating the metal salt as metal hydroxide and/or metal oxide on the surface of the microparticle, thereby obtaining the functionalized magnetic particle, wherein the mixing is performed by simultaneously pumping the dispersion and the solution of sodium hydroxide through a static mixer, wherein the static mixer has a cylindrical design, a length of at least 320 mm and an inner diameter of at least 11 mm.

The term “functionalized magnetic particle” as used herein refers to a magnetic microparticle with a surface on which at least one metal salt is deposited as metal hydroxide and/or metal oxide. The magnetic microparticle serves as carrier particle. The metal hydroxide and/or metal oxide allows the use of the functionalized particle in a wide range of applications. The metal hydroxide and/or metal oxide deposited on the microparticle can be, for example, an ion exchange material. In this case, the functionalized magnetic particle can serve as an ion exchange particle. The ion exchange particle can be used for recovering an anion from an aqueous solution. For example, the particle can be added to phosphate-containing waste water and be magnetically separated after sufficient time for phosphate adsorption.

The term “magnetic microparticle” as used herein refers to a microparticle with a diameter of about 1 μm to about 100 μm. The microparticle is magnetic and can be magnetically separated. The magnetic properties of the microparticle derive from the magnetic material comprised in the microparticle. For example, if the magnetic material is a superparamagnetic material, the microparticle is likewise superparamagnetic. The term “magnetic material” as used herein refers to any type of material that is magnetized upon application of an external magnetic field and is attracted by the gradient of a magnetic field, thereby becoming magnetically separable. For example, magnetic materials comprise ferromagnetic materials, such as iron, cobalt, nickel, aluminium nickel cobalt alloys, and nickel iron cobalt alloys, and ferrimagnetic materials, such as ferrites, magnetite (Fe₃O₄), lodestone, and cobalt iron oxides.

The microparticle used in the method of the invention has a silica based surface that derives, for example, from a silica based layer associated with the magnetic material. The term “silica based” as used herein refers to any substance comprising the element silicon as a silicon oxide. The term “layer” as used herein refers to any form of the silica based substance such as a film-like or a matrix-like form. Association of the magnetic material with the silica based layer can be mediated in any manner and accomplished by any spatial arrangement that results in the formation of a magnetic microparticle with a silica based surface. For example, the magnetic material can be packed together inside the microparticle forming a magnetic core structure that is enclosed by the silica based layer. The magnetic material can also be distributed in the silica based layer, so that the silica based layer serves as matrix in which the magnetic material is embedded.

The silica based surface gives rise to a negative zeta potential of the microparticle at neutral pH, i.e. a negative potential difference between the solution in which the microparticle is dispersed and the stationary layer of fluid attached to the dispersed microparticle. For example, microparticles with a silicon dioxide surface have a zeta potential of about −30 mV to about −40 mV at neutral pH.

The magnetic microparticle having a silica based surface is provided in an aqueous solution that has a pH of about 6 to about 8. The term “aqueous solution” as used herein refers to any solution in which the solvent is water. The aqueous solution may comprise water soluble substances that are dissolved in the solution and/or water insoluble compounds such as microparticles that are dispersed in the solution. The aqueous solution comprising the magnetic microparticle can also be referred to as a microparticle suspension.

The aqueous solution comprising the magnetic microparticle is mixed with an aqueous solution of at least one metal salt. Any metal salt can be used. The metal salt can comprise divalent metal cations of, for example, iron, magnesium, zinc, tin, calcium, copper or nickel. The metal salt can comprise trivalent metal cations of, for example, iron or aluminium. The metal salt can comprise tetravalent metal cations of, for example, zirconium. In a preferred embodiment, a mixture of two or more metal salts is used. The metal salt or the mixture of metal salts is selected according to the intended use of the functionalized particle. The aqueous solution of the at least one metal salt has a pH of about 6 to about 8.

By mixing the aqueous solution comprising the magnetic microparticle with the aqueous solution of the at least one metal salt, a dispersion is obtained. The dispersion has a pH of about 6 to about 8 and comprises the magnetic microparticle and the at least one metal salt. The dispersion is then mixed with a solution of sodium hydroxide for precipitating the metal salt as metal hydroxide and/or metal oxide on the surface of the microparticle, thereby obtaining the functionalized magnetic particle. The metal salt is precipitated directly on the silica based surface of the microparticle.

The mixing of the dispersion with the solution of sodium hydroxide is performed by simultaneously pumping the dispersion and the solution of sodium hydroxide through a static mixer. The term “static mixer” as used herein refers to a mixing device for continuously mixing fluids. The static mixer comprises a series of non-moving mixer elements which are arranged in a housing. The mixer elements may be, for example, helical elements and/or baffles. The housing and the mixer elements of the static mixer can be independently made of metal or plastic. Typical materials for static mixer components comprise stainless steel, polypropylene, polyacetal, polytetrafluoroethylene (PTFE), polyvinylidene difluoride (PVDF) and polyvinyl chloride (PVC).

The dispersion and the solution of sodium hydroxide are delivered to the static mixer by a pump which pumps them into and thus through the mixer. As the dispersion and the solution of sodium hydroxide are being passed through the mixer, the non-moving mixer elements continuously blend their components. In this way, the dispersion is mixed with the solution of sodium hydroxide. This leads to precipitation of the at least one metal salt as metal hydroxide and/or metal oxide on the surface of the microparticle.

The static mixer used in the method of the invention has a cylindrical design. In other words, the housing of the static mixer is cylindrical, i.e. the housing of the static mixer has a tubular shape.

The static mixer used in the method of the invention has a length of at least 320 mm and an inner diameter of at least 11 mm. The inventors found that the use of a static mixer that has a cylindrical design, a length of at least 320 mm and an inner diameter of at least 11 mm, leads to stable functionalized particles, even if the particles are manufactured at a large scale. After 14 days of particle storage in deionized water, the concentration of metal ions which have detached from the functionalized particles and could thus be detected in the storage solution was close to zero. Thus, the attachment of metal hydroxides and/or metal oxides on the microparticle surface that is achieved using the method of the invention is strong enough to prevent detachment of the metal hydroxides and/or metal oxides from the microparticle during the storage of the particle. This is a surprising finding since the use of a smaller static mixer or the use of a Y-piece for mixing the dispersion and the solution of sodium hydroxide did not lead to stable functionalized particles when the particles were manufactured at a large scale.

The term “large scale” as used herein refers to a manufacturing scale in which the total volume that is mixed in step b) is at least 10 L. In contrast, a volume of about 2 L or less is referred to as laboratory scale.

In more saline solutions such as tap water and waste water, the extent of detachment of the metal hydroxides and/or metal oxides from the microparticle should be even lower than in deionized water, so that the functionalized particles obtained by the method of the invention are expected to be stable over several weeks.

The inventors also tested the effect of parameters other than the mixing device when manufacturing functionalized particles at a large scale. Among the different methods tested, the method including the use of a static mixer having a cylindrical design, a length of about 320 mm and an inner diameter of about 11 mm was the only method that resulted in stable functionalized particles. Accordingly, the inventors demonstrated that a cylindrical static mixer that has a minimum length and diameter is necessary to obtain stable functionalized particles.

The attachment of metal hydroxides and/or metal oxides on the microparticle surface that is achieved using the method of the invention is also strong enough to prevent detachment of the metal hydroxides and/or metal oxides from the microparticle when the particle is dispersed and magnetically separated again, even in cycling repetitions. Accordingly, a filtering procedure or other purification efforts that would be necessary to eliminate detached metal ions from a solution in which the particles have been stored or applied in order to prevent the pollution of natural waters is dispensable.

In addition, analyses of phosphate adsorption and desorption characteristics of functionalized particles comprising a ZnFeZr adsorber material gave very good results.

Taken together, the method of the invention provides a simple and fast procedure for manufacturing highly stable functionalized magnetic particles. The high stability of the functionalized particles facilitates their long-term storage and their re-use for many times, for example over many cycles of waste water treatment.

The method of the invention is particularly suitable for large-scale manufacturing. The inventors found that the method of the invention can be used to manufacture about 1 kg of functionalized magnetic particles in one cycle and that it can also be further up-scaled. Therefore, the method of the invention facilitates a commercial production of large amounts of stable functionalized magnetic particles that can be applied in industrial applications such as in waste water treatment in waste water plants.

In a preferred embodiment, the dispersion and the solution of sodium hydroxide together have a volume of at least about 20 L, preferably of at least about 25 L, more preferred of at least about 28 L. The volume of the dispersion and the volume of the solution of sodium hydroxide together account for the total volume that is mixed in step b).

In the functionalized magnetic particle, the metal salt is deposited on the surface of the microparticle as metal hydroxide and/or metal oxide by physisorption, i.e. the deposition of the metal hydroxide and/or metal oxide on the microparticle is mediated by physical interactions and not by formation of chemical bonds. The deposition of the metal hydroxide and/or metal oxide on the surface of the microparticle shows only minor effects on size, size distribution and magnetism of the microparticle. For example, if the microparticle is superparamagnetic, the functionalized particle is also superparamagnetic. Since the microparticle can be magnetically separated, the functionalized particle is likewise magnetically separable.

In a preferred embodiment, the at least one metal salt is precipitated as metal hydroxide and metal oxide, i.e. as a mixture of metal hydroxide and metal oxide, on the surface of the microparticle. In the method of the invention, most metal salts will precipitate as a mixture of metal hydroxide and metal oxide on the surface of the microparticle. For example, when zinc chloride, iron (III) chloride and zirconyl chloride are used as metal salts, they are usually precipitated as a mixture of metal hydroxides and metal oxides on the surface of the microparticle.

In another embodiment, the at least one metal salt is precipitated as metal hydroxide or as a mixture of metal hydroxide and metal oxide on the surface of the microparticle.

The method for manufacturing the functionalized particle can be performed in batch process or in continuous process. In batch process, the solution comprising the microparticle is preferably mixed with the solution of the at least one metal salt under stirring. Subsequently, the resulting dispersion and the solution of sodium hydroxide are placed in separate reservoirs that are connected to a pump that is connected to the static mixer. The dispersion and the solution of sodium hydroxide are then simultaneously pumped through the static mixer.

In a preferred embodiment, the method of the invention is used to manufacture at least about 250 g, preferably at least about 500 g, more preferred at least about 1 kg of functionalized magnetic particles in one cycle.

In a preferred embodiment, step a) and/or step b) is performed as a continuous process. In continuous process, the solution comprising the microparticle, the solution of the at least one metal salt and the solution of sodium hydroxide are continuously supplied. To do so, the three solutions are provided in separate reservoirs that can be continuously and independently refilled without interrupting any of the mixing steps. The reservoirs of the solution comprising the microparticle and the solution of the at least one metal salt are preferably connected to a pump that is connected to a first mixer and the two solutions are simultaneously and continuously pumped through the first mixer. The resulting dispersion and the solution of sodium hydroxide are then simultaneously and continuously pumped through the static mixer, which is the second mixer in this case. The first mixer can also be a static mixer.

The mixer elements of the static mixer may have a variety of designs. In a preferred embodiment, the static mixer has helical mixer elements. Helical mixer elements impart an alternate left and right twist. A static mixer with helical mixer elements is known as spiral mixer. The helical mixer elements may be 180° helical twists alternating in either right- or left-hand rotation, wherein the alternating twists are joined in a way so that their leading and trailing edges are mutually perpendicular.

In another embodiment, the static mixer has square mixer elements. The square mixer elements can be alternating left- and right-hand elements with intermittent flow inverters that channel fluids from the walls of the mixer to the center of the mixer and back.

The static mixer may be a disposable static mixer, for example a disposable spiral mixer.

The duration of step a) is selected to be long enough to achieve a homogenous distribution of the microparticles and the metal salts in the dispersion. Depending on the volumes of the solutions used and the way of mixing, the duration of step a) may vary. For example, the duration of step a) can range from about 5 sec to about 10 min. In a preferred embodiment, step a) is performed for about 1 to about 5 minutes, preferably for about 5 minutes. The inventors found that a time span of 5 minutes is sufficient to achieve a homogenous distribution of the microparticles and the metal salts in the dispersion when preparing a dispersion with a volume of 14 l and mixing the two solutions used as starting materials under stirring.

The duration of step b) may vary depending on the volumes that need to be pumped through the static mixer, the dimensions of the mixer and the flow rate. For example, the duration of step b) can range from about 30 sec to about 1 hour. In a preferred embodiment, step b) is performed for about 15 minutes.

The duration of each of the steps is preferably short, such as in a range from about 30 sec to about 15 min. Short durations of step a) and/or step b) lead to a fast completion of the manufacturing process, allowing the production of the functionalized particle in a time-efficient manner. The fast production process also saves energy for operating stirring and pumping devices. Thus, the method is not only fast but also cost-efficient and ecologically friendly.

The dimensions of the mixer are selected to ensure a rapid and complete mixing of the dispersion and the solution of sodium hydroxide. In a preferred embodiment, the static mixer has a length of 320 mm and an inner diameter of 11 mm. The inventors found that for a total volume mixed in step b) of about 30 L, the use of such a mixer leads to a rapid and complete mixing of the dispersion and the solution of sodium hydroxide. It was also found to result in stable functionalized particles. A static mixer with a length of 320 mm and an inner diameter of 11 mm is also suitable for mixing higher volumes in step b). In this case, more time may be needed for passing the fluids through the mixer.

In another embodiment, the static mixer has a length of 13.77 cm and an inner diameter of 16 mm.

In a preferred embodiment, a flow rate through the static mixer is about 0.5 to about 4 L/min, preferably about 0.9 to about 2.8 L/min, more preferred about 1.5 to about 2.0 L/min, most preferred about 1.8 L/min. The flow rate through the static mixer refers to the total volume of fluid that is pumped through the static mixer per minute. For example, in case the dispersion and the solution of sodium hydroxide are mixed in a ratio of 1:1 and the dispersion and the solution of sodium hydroxide are each pumped from their respective reservoir to the static mixer at a rate of 0.9 L/min, the flow rate through the static mixer is 1.8 L/min. The flow rate through the static mixer can be adjusted by adjusting the operating parameters of the pump that pumps the fluids through the static mixer. For example, the pump can be set to about 240 U/min. The flow rate is selected to ensure a rapid and complete mixing of the dispersion and the solution of sodium hydroxide. The flow rate may be adjusted depending on the dimensions of the mixer and/or the volumes applied.

In a preferred embodiment, the static mixer has a length of 320 mm and an inner diameter of 11 mm and the flow rate is 1.5-2.0 L/min.

In another embodiment, the static mixer has a length of 13.77 cm and an inner diameter of 16 mm and the flow rate is 1.5-2.0 L/min.

The dimensions of the static mixer should not be too large in relation to the flow rate in order to ensure a rapid mixing of the dispersion and the solution of sodium hydroxide.

In a preferred embodiment, the dispersion and the solution of sodium hydroxide are pumped through the static mixer at a flow rate that provides an average residence time in the mixer of about 2 to about 30 min, preferably of about 10 to about 20 min, more preferred of about 15 min. The residence time is the time that is needed for the dispersion and the solution of sodium hydroxide to be passed through the mixer.

In a preferred embodiment, the pumping is performed by means of a peristaltic pump. The use of a peristaltic pump ensures a uniform flow of the dispersion and the solution of sodium hydroxide into the static mixer. Other types of pumps such as a diaphragm pump or a piston pump can also be used.

In a preferred embodiment, step a) and/or step b) is performed at room temperature, preferably step a) and step b) are performed at room temperature. Therefore, the energy demand of the method remains low and the functionalized particles are manufactured in a cost-efficient manner.

In a preferred embodiment, the aqueous solution comprising the magnetic microparticle is obtained by dispersing the magnetic microparticle in deionized water.

In a preferred embodiment, the aqueous solution comprising the magnetic microparticle has a microparticle concentration of about 5 to about 50 g/L, preferably of about 10 to about 30 g/L, more preferred of about 20 g/L.

In a preferred embodiment, the aqueous solution of the at least one metal salt is obtained by dissolving the metal salt in deionized water.

In a preferred embodiment, the metal salt is a metal chloride, preferably zinc chloride, iron (III) chloride or zirconyl chloride. The use of metal chlorides may promote the adsorption of chloride anions to the metal hydroxides and/or metal oxides, which is favorable for an anion exchange with phosphate.

In a preferred embodiment, the aqueous solution of the at least one metal salt comprises more than one metal salt, preferably two metal salts, more preferred three metal salts. The metal salts of an aqueous solution of three metal salts are preferably zinc chloride, iron (III) chloride and zirconyl chloride. The metal hydroxides and/or metal oxides that result from precipitation of a mixture of these metal salts were found to be a very selective and very efficient phosphate adsorber material, which is also referred to as ZnFeZr adsorber material. The material was also found to be suitable for recovering phosphate therefrom so that the phosphate as well as the particles may be reused.

In a preferred embodiment, the aqueous solution of the at least one metal salt has a metal salt concentration of about 5 to about 70 g/L, preferably of about 10 to about 50 g/L, more preferred of about 32 g/L.

The ratio of metal salts and magnetic microparticles that are used for obtaining the dispersion is selected according to the desired content of metal hydroxides and/or metal oxides of the resulting particle. Accordingly, before mixing, the microparticle concentration of the solution comprising the microparticle and the metal salt concentration of the solution of the at least one metal salt are selected or adjusted to yield the desired ratio of metal hydroxides and/or metal oxides and microparticles. In a preferred embodiment, the functionalized particle comprises about 10-40 wt %, preferably about 20-23 wt %, more preferred about 20 wt % metal hydroxides and/or metal oxides.

As an example, 10 L of a solution comprising magnetic microparticles (i.e. 10 L of a microparticle suspension) of about pH 7-8 with a concentration of 20 g/L microparticles are mixed with 4 L metal salt solution of about pH 7-8 with a concentration of metal salts of about 32 g/L to obtain a functionalized particle with a content of metal hydroxides and/or metal oxides of about 20 wt %. If a particle with a higher content of metal hydroxides and/or metal oxides is desired, the concentration of the microparticle suspension may be decreased and/or the concentration of the metal salt solution may be increased.

In a preferred embodiment, the aqueous solution comprising the magnetic microparticle and the aqueous solution of the at least one metal salt are mixed in a ratio of about 5:1 to about 1:1, preferably of about 2.5:1. For example, 10 L of a solution comprising magnetic microparticles are mixed with 4 L of a solution of one or more metal salts.

In a preferred embodiment, the aqueous solution comprising the magnetic microparticle and the aqueous solution of the at least one metal salt are mixed by stirring. The stirring is preferably performed at about 300 rpm. In a further preferred embodiment, the stirring is performed at about 300 rpm for about 5 minutes at room temperature.

In a preferred embodiment, the solution of sodium hydroxide has a sodium hydroxide concentration of about 0.1 to about 0.35 M, preferably of about 0.1 to about 0.2 M, more preferred of about 0.15 M.

In a preferred embodiment, the dispersion and the solution of sodium hydroxide are mixed in a ratio of about 1:1. This is achieved by pumping the same volume of each the dispersion and the solution of sodium hydroxide into the static mixer at the same rate. The two fluid streams that enter the static mixer will thus have the same size. This leads to a good mixing of the dispersion with the solution of sodium hydroxide in the static mixer.

In a preferred embodiment, the solution of sodium hydroxide is further used in advance-flow and in after-flow in the static mixer to ensure that the dispersion is steadily contacted with the solution of sodium hydroxide during step b) of the method of the invention.

The mixture obtained in step b) is alkaline. For example, the mixture obtained in step b) has a pH of about 12-12.5.

In a preferred embodiment, the method further comprises
c) isolating the functionalized magnetic particle by magnetically separating the particle from the mixture obtained in step b) and removing the supernatant;
d) dispersing the isolated particle in deionized water; and
e) adjusting the pH of the dispersion obtained in step d) to 7.5-8.0, preferably by adding a solution of hydrochloric acid to the dispersion.

Adjusting the pH of the dispersion obtained in step d) is preferably performed using hydrochloric acid.

In a preferred embodiment, the method further comprises
f) washing the isolated particle with deionized water, wherein step f) is preferably repeated for at least two times.

The isolated particle may be washed with deionized water by dispersing the particle in deionized water, stirring the dispersion for about 1 to about 2 minutes, preferably for about 2 minutes, magnetically separating the particle from the dispersion and removing the supernatant.

In a preferred embodiment, step c), step d), step e) and/or step f) is performed at room temperature, preferably steps c), d), e) and f) are all performed at room temperature. Therefore, the energy demand of the method remains low and the functionalized particles are manufactured in a cost-efficient manner.

In a preferred embodiment, the magnetic microparticle has a diameter of about 1 to about 70 μm, preferably of about 5 to about 25 μm, more preferred of about 10 to about 15 μm. The inventors found that the use of microparticles of this size results in functionalized particles that can be efficiently magnetically separated and redispersed. Further, this size range leads to a good surface to volume ratio of the functionalized particle.

In a preferred embodiment, the magnetic microparticle is a soft magnetic or a superparamagnetic microparticle. The almost total or total lack of remanent magnetization of soft magnetic and superparamagnetic materials, respectively, avoids particle aggregation by mutual attraction following magnetization in the field of a separator. Therefore, particles can be redispersed in an aqueous solution after removing them from the magnetic separator, enabling recycling of the particles. Further, soft magnetic materials and superparamagnetic materials show no or only minor energy loss associated with magnetic hysteresis. Thus, no or only a minor amount of energy is transformed into heat upon reversal of magnetism, keeping the temperature of the material stable.

Soft magnetic materials include for example ferrites, nickel iron alloys and cobalt iron alloys. Superparamagnetic materials include for example iron oxide nanoparticles such as magnetite nanoparticles.

In a preferred embodiment, the silica based surface of the microparticle is a silicon dioxide surface. Silicon dioxide is insoluble in water and in most acids. Microparticles with a silicon dioxide surface have a zeta potential of about −30 mV to about −40 mV at neutral pH. Amorphous silicon dioxide has a relatively high specific surface area, thus facilitating the precipitation of the metal salt as metal hydroxide and/or metal oxide onto the surface of the microparticle.

In a preferred embodiment, the magnetic microparticle is provided as a microparticle regained from a functionalized magnetic particle by treating the functionalized particle at a pH of about 0.5 to about 3 for detaching the metal hydroxide and/or metal oxide from the surface of the microparticle. Since the deposition of the metal hydroxide and/or metal oxide on the microparticle does not involve the formation of chemical bonds, the microparticle as carrier is preserved. The process of metal hydroxide and/or metal oxide deposition can be reversed by acidic treatment of the particle. For example, if a decrease in anion exchange capacity of the particle is observed, disposed metal hydroxide and/or metal oxide can be disintegrated by treating the particle at a pH of about 0.5 to about 3. By disintegration of the metal hydroxide and/or metal oxide, an unmodified microparticle is regained. After magnetic separation of the microparticle from the acidic solution, the microparticle can be re-coated by the method of the invention. The simple removal and replacement of the metal hydroxide and/or metal oxide allows continuous re-use of the microparticle. Thus, time and costs for the production of new microparticles are saved.

In a second aspect, the present invention relates to a particle for recovering an anion from an aqueous solution obtainable by the method of the invention.

In a third aspect, the present invention relates to the use of the particle of the invention for recovering an anion from an aqueous solution. The term “anion” as used herein includes inorganic anions as well as organic anions that are soluble in water. The anion may have any size and any composition. The anion may be, for example, chloride, bromide, nitrate, carbonate, sulphate or phosphate. For recovering an anion from an aqueous solution, the particle of the invention is applied to the solution and, after a sufficient period of time for anion exchange, it is removed from the solution by magnetic separation. After magnetic separation, the particle can easily be regenerated and reused many times. The specificity of the functionalized particle for a given anion depends on the metal salts used. For example, a mixture of zinc chloride, iron (III) chloride and zirconyl chloride results in particles that are highly specific for phosphate.

In a preferred embodiment, the anion is a phosphate anion. Phosphate is a scarce resource that needs to be recovered from waste water for recycling but also to prevent eutrophication of natural waters. Depending on the metal salts used, the particle of the invention shows a high specificity for phosphate. Therefore, no contaminants are recovered together with phosphate and phosphate can be retrieved from the functionalized particles as a pure product. The inventors found that in case of functionalized particles comprising a ZnFeZr adsorber material, only 20 minutes of contact time with phosphate-containing water at a pH of about 7 is sufficient to achieve adsorption of 90% of the phosphate to the particles.

In a preferred embodiment, the anion is retrieved from the functionalized particle by ion exchange. Due to the reversible adsorption of anions by the metal hydroxide and/or metal oxide, the functionalized particles can be easily regenerated and re-used. Regeneration of the metal hydroxide and/or metal oxide of the particles is achieved by retrieval of the anion by incubating the particles in a suitable desorption solution. Retrieved phosphate is present in concentrated form in the desorption solution and available for recycling or disposal. After magnetic separation from the desorption solution, the functionalized particles can be used again, for example they can be redispersed in waste water, which saves time and costs for the production of new particles.

In a preferred embodiment, the desorption solution comprises sodium hydroxide. The concentration of sodium hydroxide is preferably in the range from about 0.1 M to about 3 M. For example, the desorption solution is a solution of 1 M NaOH at a pH of about 13, and particles are incubated therein for at least about 20 minutes.

In a preferred embodiment, the anion is recovered from waste water. Due to the high anion adsorption capacity, the magnetic separability and the simple regeneration of the functionalized particles, a cost- and energy-efficient process for anion recovery from waste water is facilitated. As particle regeneration does not require any disruption of waste water flow through a waste water plant, the particles can be applied in a continuous process of waste water treatment. The recovery of anions such as phosphate from waste water is economically and environmentally important as it facilitates recycling of non-renewable raw materials and protects lakes and rivers from pollution.

In a further aspect, the present invention relates to the use of the particle of the invention for catalysing a chemical reaction by heterogeneous catalysis. Particles with a metal hydroxide and/or metal oxide that comprises suited cations can be used as catalysts for a multitude of reactions, for example for vegetable oil transesterification reactions that play an important role in the production of biodiesel, such as the reaction of soybean oil with methanol. Advantageously, the particle of the invention provides a magnetic and thus retrievable catalyst particle for heterogeneous catalysis.

In a further aspect, the present invention relates to the use of the particle of the invention as a carrier for a biochemical molecule, preferably an enzyme, immobilized on the metal hydroxide and/or metal oxide. The term “biochemical molecule” includes any molecule present in nature or artificially modified variants of a naturally occurring molecule. For example, biochemical molecules comprise proteins, such as enzymes and nucleic acids, such as RNA and DNA. Enzymes that can be immobilized on the metal hydroxide and/or metal oxide include for example acetylcholinesterase, horseradish peroxidase, urease, glucose oxidase, fructose-6-phosphate aldolase, and diamine oxidase. Other examples of biochemical molecules that can be immobilized on the metal hydroxide and/or metal oxide include iron porphyrins. The particle carrying a biochemical molecule can be used in many different technical fields such as for catalysing a chemical reaction or for biosensing applications.

In a further aspect, the invention is directed to the use of the particle of the invention as a carrier for an artificial molecule, preferably a medicament, immobilized on the metal hydroxide and/or metal oxide.

Further aspects of the invention will be apparent to the person skilled in the art by the enclosed description of the examples, in particular the scientific results.

### Examples

1. Materials and methods

### 1.1 Materials

Iron(III) chloride hexahydrate (FeCl₃.6H₂O, 99%+), iron(II)chloride tetrahydrate (FeCl₂.4H₂O, 99%+) and zirconium(IV) oxychloride octahydrate (ZrOCl₂.8H₂O, 99.5%), were purchased from Sigma-Aldrich, Germany, and used without further purification. Zinc chloride (ZnCl₂), hydrochloric acid (HCl, 36 wt %) and sodium hydroxide (NaOH pellets) were purchased from Carl Roth, Germany, and used without further purification. Ammonium hydroxide solution (NH₄OH, 25 wt %) in water, nitric acid (HNO₃, 1 M, diluted from a 53 wt % solution), sodium silicate (water glass) solution (36 wt %, molar ratio of SiO₂:Na₂O=3:1, Na₂Si₃O₇) were obtained from Fischar Chemicals, Germany, and used without further purification.

### 1.2 Synthesis of Superparamagnetic Microparticles

8.64 g (32 mmol) of FeCl₃.6H₂O and 3.18 g (16 mmol) of FeCl₂.4H₂O were dissolved in 100 ml deionized water without any protection from oxygen environment at 20° C. 20 ml 25 wt % aqueous ammonium hydroxide solution was diluted with 100 ml water. The two solutions were mixed under stirring. The precipitate (approx. 3.9 g) was washed once (dispersing it in water and magnetically separating again) and suspended in 120 ml deionized water. The suspension was mixed with 120 ml nitric acid (0.66 M). The sol was further stabilised by carboxylic acid. The resulting functionalised nanoparticle sol had a pH of 1 to 2.

To the functionalised nanoparticle sol 88 ml of 25 wt % ammonium hydroxide diluted in 80 ml deionized water was added. The mixture was heated to 70° C. under air and stirring. Sodium silicate solution (molar ratios NH₄OH:HNO₃:Na₂Si₃O₇=27:1:0.4) was added slowly through a syringe needle. The reaction mixture was stirred for an additionally 5 min at 70° C. Subsequently, the product was magnetically removed and washed.

Analyses of the resulting product showed that superparamagnetic nanoparticles of magnetite (Fe₃O₄) were incorporated into a silica matrix, that the size range of the resulting microparticles was from about 1 to about 50 μm, that the microparticles were superparamagnetic (with 30 emu/g saturation magnetization) and have a relatively large surface area of about 50 to about 75 m²/g. The surface of the microparticles was composed of amorphous silica. These microparticles were used as magnetic carriers for the adsorber material (metal hydroxides and metal oxides).

### 1.3 Standard Method of Manufacturing Functionalized Particles in 28 L Scale

A solution of microparticles was prepared by dispersing 200 g superparamagnetic microparticles in 10 L deionized water (20 g/L).

A solution of metal salts was prepared by dissolving the following metal salts in 4 L deionized water:

74 g ZnCl₂ (18.5 g/L),
24.8 g FeCl₃.6H₂O (6.2 g/L), and
29 g ZrOCl₂.8H₂O (7.25 g/L).

The concentration of microparticles and the concentration of metal salts were adapted to one another to yield the desired ratio of microparticles and adsorber material.

The solution of metal salts (pH 7-8) was added to the solution of superparamagnetic microparticles (pH 7-8) under stirring (300 rpm). The resulting dispersion was stirred for 5 min at 300 rpm.

The resulting dispersion had a volume of 14 L with 14.3 g/L superparamagnetic microparticles, 5.3 g/L ZnCl₂, 1.8 g/L FeCl₃.6H₂O, and 2.0 g/L ZrOCl₂.8H₂O.

A solution of 0.15 M NaOH (pH 10) was prepared. The volume of the solution was 15 L.

The dispersion, which was obtained by mixing the solution of metal salts with the solution of microparticles, and the solution of NaOH were simultaneously and at the same rate pumped through a static mixer using a peristaltic pump (Ismatec MCP-Standard ISM 404 with SB 2V pump head, Cole-Parmer GmbH, Germany) which was set to about 240 U/min. The static mixer was a disposable spiral mixer having a cylindrical design, a length of about 250 mm and an inner diameter of about 8 mm (MXR 160, product no. 7700927, Nordson Deutschland GmbH). The elements in the mixers were 180° helical twists alternating in either right- or left-hand rotation. These alternating elements were joined so that their leading and trailing edges were mutually perpendicular. The elements were made of acetal while the housing of the spiral mixer was polypropylene. The dispersion and the solution of NaOH were mixed in a ratio of 1:1 and were each pumped from their respective reservoir to the static mixer at a rate of about 0.9 L/min, so that the flow rate through the mixer was about 1.8 L/min. The residence time in the mixer was about 15 min.

The metals salts were precipitated as metal hydroxides and metal oxides on the surface of the magnetic microparticles. In other words, the magnetic microparticles, which were used as carrier particles, were functionalized with metal hydroxides and metal oxides (adsorber material, adsorbent).

The functionalized magnetic particles were isolated from the mixture by magnetic separation using a magnetic plate and removal of the supernatant. The functionalized particles were then dispersed in deionized water. The pH of the resulting dispersion was adjusted to pH 7.5-8.0 using an aqueous solution of hydrochloric acid and the functionalized particles were then washed in deionized water three times.

All steps were performed at room temperature.

1.4 Deviations from the Standard Method of Manufacturing Functionalized Particles in 28 L Scale

The following deviations from the standard method of manufacturing functionalized particles in 28 L scale were tested:
A) The concentration of the solution of NaOH was increased from 0.15 M to 0.5 M.
B) The temperatures of the fluids during particle manufacture was set to 60° C.
C) The content of the adsorber material was reduced from 20 wt % to 10 wt %.
D) A different static mixer was used. The static mixer used was also a disposable spiral mixer having a cylindrical design, but had a length of about 320 mm and an inner diameter of about 11 mm (MXR 161, product no. 7701028, Nordson Deutschland GmbH). The elements in the mixers were also 180° helical twists alternating in either right- or left-hand rotation. These alternating elements were joined so that their leading and trailing edges were mutually perpendicular. The elements were made of acetal while the housing of the spiral mixer was polypropylene.
E) A different type of mixer was used. The dispersion, which was obtained by mixing the solution of metal salts with the solution of microparticles, and the solution of NaOH were not pumped through a static mixer, but through a Y-piece.

### 1.5 Stability Analyses

To analyse the stability of the functionalized magnetic particles, samples of dispersions of the particles in deionized water were continuously monitored for at least two weeks. Every day, each sample was stirred for 15 minutes using a KPG stirrer and an aliquot was taken from the sample. The particles in the aliquot were separated from the supernatant by magnetic separation using a hand magnet and removal of the supernatant. The supernatants were analysed with respect to colour, pH, electrical conductivity and concentrations of dissolved metal ions from the metal salts used and dissolved silicon ions.

The concentrations of dissolved metal ions and dissolved silicon ions were determined by ICP-OES (Inductively Coupled Plasma Optical Emission Spectrometry).

### 2. Results

The amount of functionalized magnetic particles obtained in 28 L scale was about 250 g. Deposition of the adsorber material was confirmed by scanning electron microscopy and X-ray diffraction of washed, magnetically separated and dried particles. Scanning electron microscopy and energy dispersive X-ray analysis revealed that the adsorber material was composed of both crystalline and amorphous structures of metal hydroxides and metal oxides of the metals used.

The particles obtained from the standard method of manufacturing functionalized particles in 28 L scale (described in section 1.3 above) and from the deviations A), B), D) and E) (described in section 1.4 above) had a ratio of microparticles to adsorber material of about 4:1, corresponding to 20 wt % adsorber material.

The particles obtained by the standard method of manufacturing functionalized particles in 28 L scale were found to be unstable. After only few days of storage, adsorber material detached from the microparticle surface. Therefore, the inventors tested various deviations from the standard method.

All deviations from the standard method of manufacturing functionalized particles in 28 L scale tested resulted in functionalized particles. Directly after manufacture and during subsequent washing steps, no detachment of adsorber material could be observed.

The results of the stability analyses are described below. Samples A)-E) designate the supernatants of aliquots taken from functionalized particles which were obtained by the methods including deviations A) to E), respectively (see section 1.4 above).

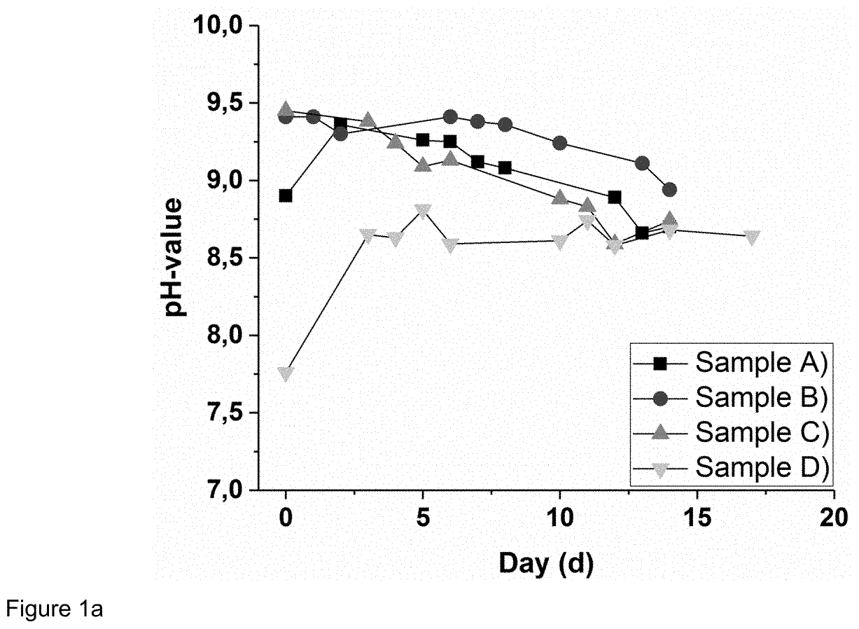

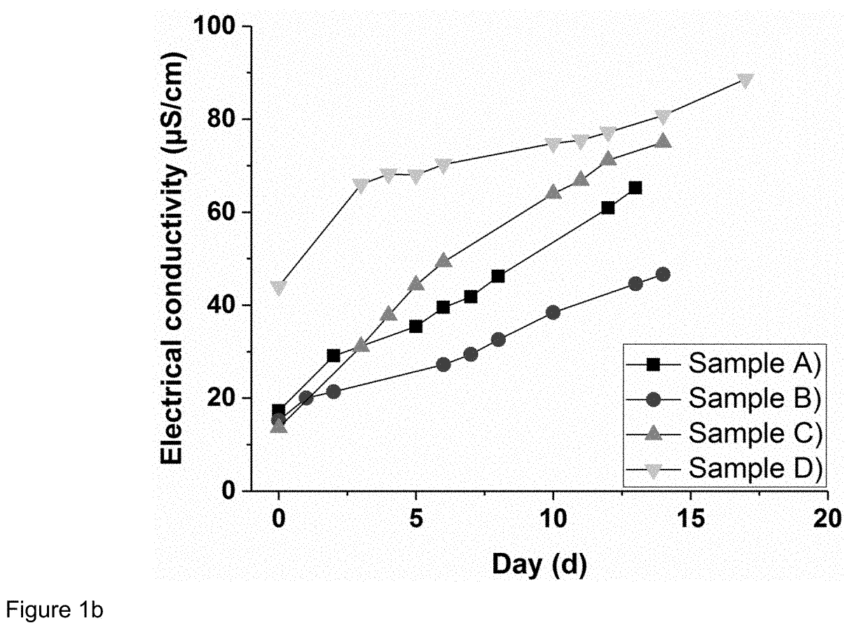

FIG. 1a shows the time course of pH of samples A) to D) during the monitoring period. It was found that for all samples, the pH is above the value set between 7.5 and 8 during the synthesis before washing. Samples A), B) and C) had a pH of approximately between 9 and 9.5 on the first day. The pH decreased continuously over time to a value between 8.5 and 9 after 14 days. The pH of sample D) is still approximately in the neutral range at the beginning of the monitoring period, then rises rapidly and remains relatively stable at values between 8.5 and 9.

FIG. 1b shows the time course of electrical conductivity of samples A) to D) during the monitoring period. It was found that all samples showed an increase in conductivity. The conductivity of the samples increased relatively evenly over the time course of the monitoring period of 2-3 weeks. Conductivity values ranged from 10-100 μS/cm.

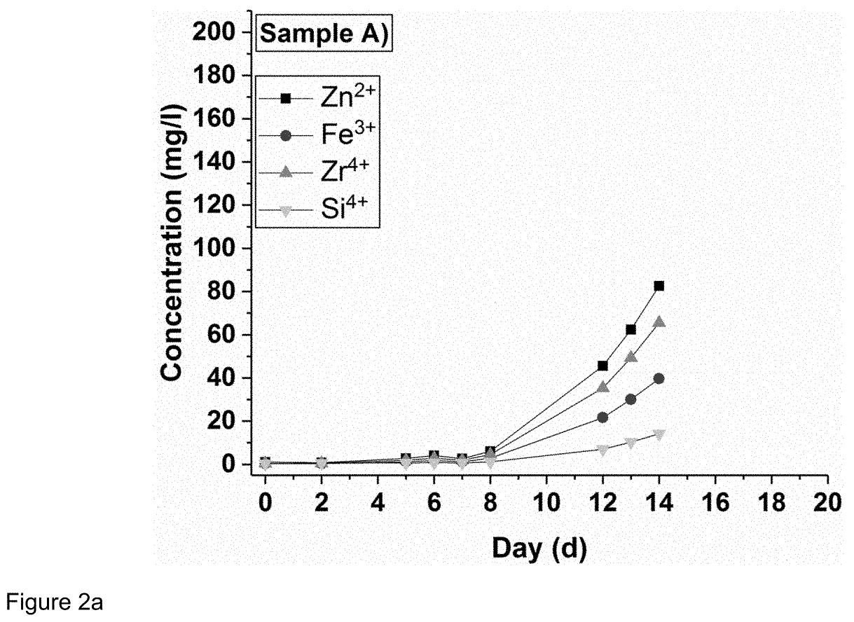

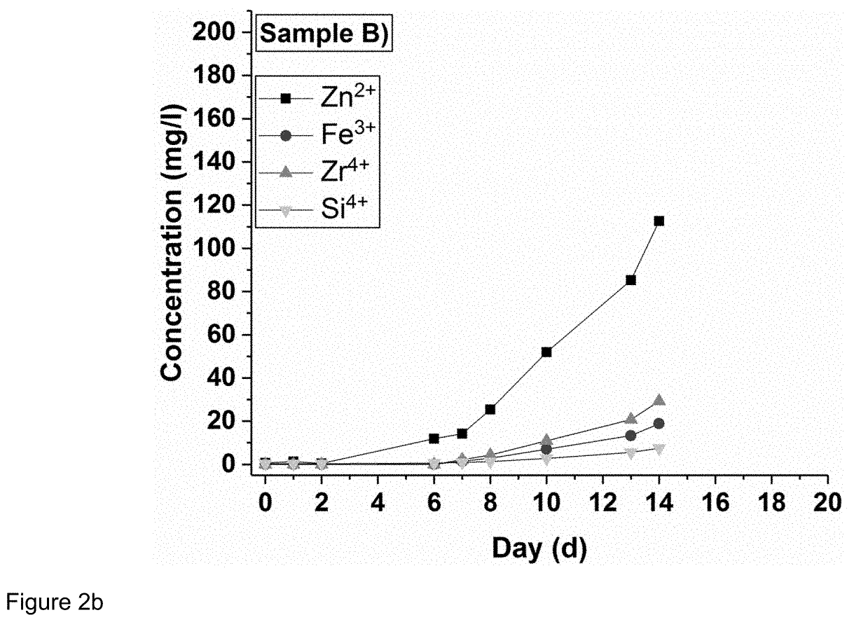

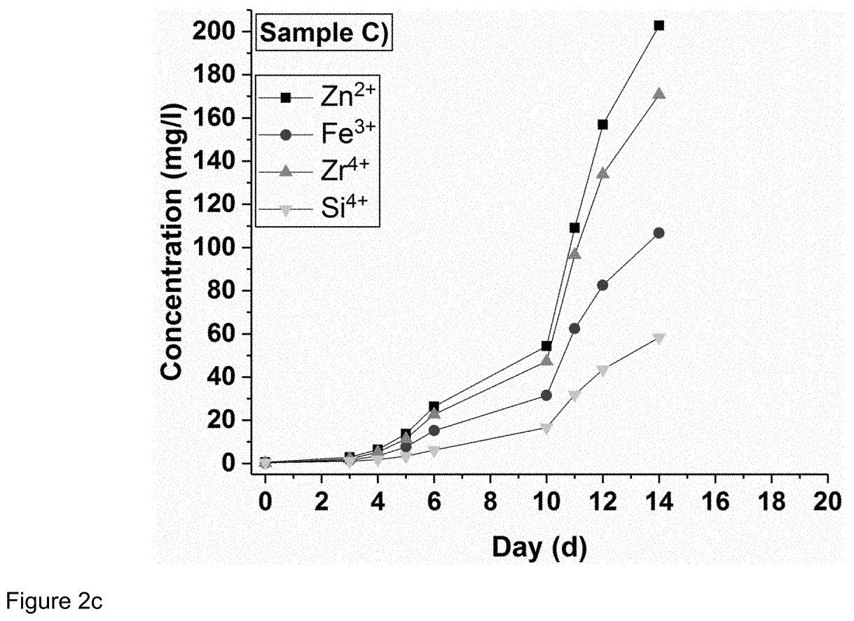

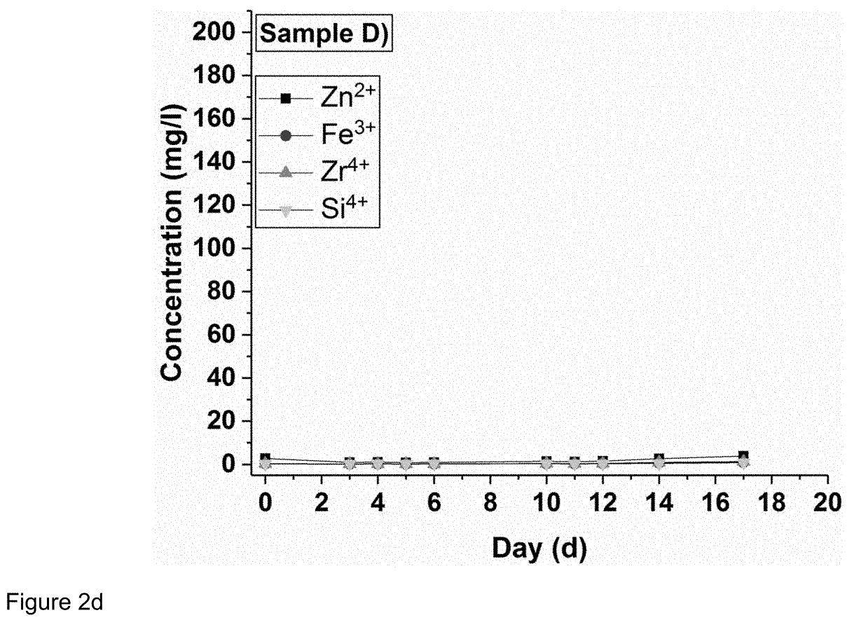

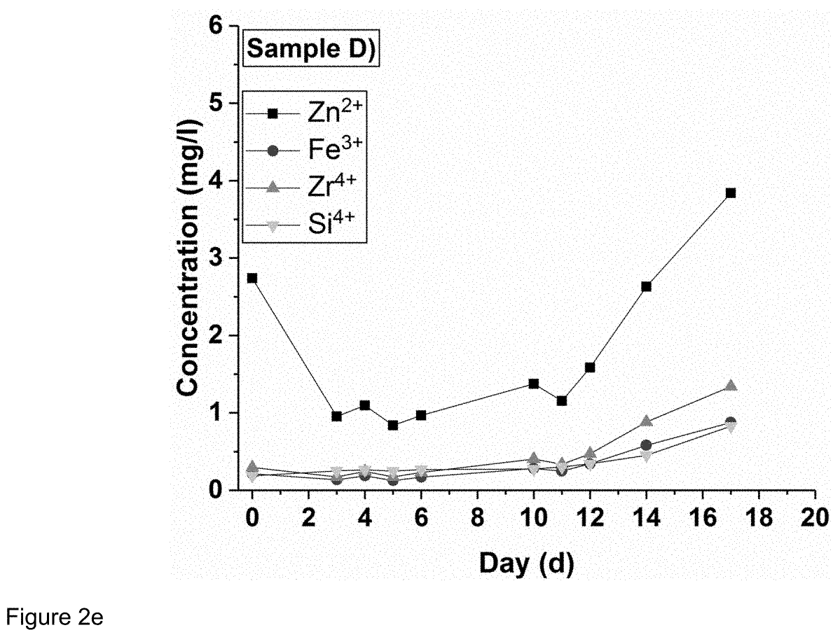

FIG. 2 shows the time course of concentrations of dissolved metal ions and dissolved silicon ions in the supernatants of the functionalized particles during the monitoring period. FIG. 2a shows the results for sample A). FIGS. 2b to 2d show the results for samples B) to D), respectively. FIG. 2e shows the results for sample D) with an enlarged y-axis.

For a better comparison of the samples with each other, the graphs are plotted with the same scale apart from FIG. 2e which has an enlarged y-axis. ICP-OES analyses were performed for the elements Zn, Fe, Zr and Si.

The graphs show that at the beginning of the monitoring period, the concentration of the analyzed elements was almost zero in all samples and then increased over time. The order of the ion concentrations was the same for all samples. The highest concentration was found for zinc, followed by zirconium, iron and silicon.

Surprisingly, the inventors found significant differences between the samples with respect to the time point of the first increase in ion concentrations and the absolute amount of dissolved ions.

In sample A), ion concentration remained low until the 8th day of the monitoring period (FIG. 2a). Small fluctuations could already be seen at day 6. After day 8, the concentration increased relatively evenly for all elements. The beginning of an exponential increase may be noted. After 14 days of monitoring, a maximum concentration of about 80 mg/L for zinc, 65 mg/L for zirconium, 40 mg/L for iron and 15 mg/L for silicon is reached. Based on these results, it can be concluded that the functionalized particles obtained by the method including deviation A) will remain stable for about one week.

In sample B), the concentration of dissolved zinc ions increased earlier than in sample A), namely at least from day 6 of the monitoring period (FIG. 2b). The concentrations of the other ions remained low until day 8 before increasing as well. Like in sample A), the beginning of an exponential increase may be seen. After 14 days of monitoring, the concentration of zinc was higher than in sample A), namely about 110 mg/L. However, the concentrations of zirconium at 30 mg/L, iron at 20 mg/L and silicon at 7 mg/L were much lower than those of sample A). Overall, the functionalized particles obtained by the method including deviation B) showed a slightly lower stability compared to those obtained by deviation A).

In sample C), it was observed that the adsorber material of the particles detached much earlier. A significant increase of ion concentrations was already observed from the 4th day of the monitoring period (FIG. 2c). Like in samples A) and B), the increase may be an exponential increase. After 14 days of monitoring, an approximation to a maximum concentration was already detectable. The concentrations of metal ions after 14 days were the highest among all samples analyzed. They were about 200 mg/L for zinc, 170 mg/L for zirconium, 110 mg/L for iron and 60 mg/L for silicon. Thus, by far the most adsorber material detached from the microparticle surface. It can be concluded that the functionalized particles obtained by the method including deviation C) will not be stable beyond only 4 days of storage.

Surprisingly, sample D) showed completely different time courses for the concentrations of dissolved ions. The ion concentrations were so low that they are no longer clearly detectable with the applied scale (FIG. 2d). Therefore, the results for sample D) are also shown in a graph with an enlarged y-axis (FIG. 2e). Overall, a very slight increase in the ion concentrations could be observed, with zinc having the highest concentration. The increase is very low compared to samples A), B) and C). After 14 days of monitoring, the concentration of zinc was about 2.5 mg/L. The concentrations of the other ions were in the range between 0 and 1 mg/L. In the further course of the monitoring period which was extended until day 17, a slight increase in the concentrations of all ions could be seen. Compared to the other samples, however, this increase is minimally small. Based on these results, it can be concluded that the functionalized particles obtained by the method including deviation D) will be very stable for at least 2 weeks and almost no adsorber material will detach. Thus, these particles were found to be much more stable than the particles obtained by deviations A), B) and C).

The amount of dissolved silicon was only significant in samples A), B) and C).

The functionalized particles which were obtained by the method of manufacturing functionalized particles including deviation E), i.e. using a Y-piece instead of the static mixer, were found to be unstable. After only few days of storage, adsorber material detached from the microparticle surface.

The ion concentrations relate to the colour of the samples. The colour impression gained from samples A) to D) during the monitoring period is given in Table 1.

TABLE 1

| Day | Sample A) | Sample B) | Sample C) | Sample D) |
|---|---|---|---|---|
| 0 | colourless, clear | colourless, clear | colourless, clear | colourless, clear |
| 1 | | colourless, clear | | |
| 2 | colourless, clear | colourless, clear | | |
| 3 | | | colourless, clear | colourless, clear |
| 4 | | | colourless, clear | colourless, clear |
| 5 | slightly yellowish | | slightly yellowish | colourless, clear |
| 6 | slightly yellowish | milky | slightly yellowish | colourless, clear |
| 7 | slightly yellowish | milky | | |
| 8 | slightly yellowish | milky | | |
| 10 | | yellow, cloudy | yellow, cloudy | colourless, clear |
| 11 | | | yellow, cloudy | colourless, clear |
| 12 | yellowish | | yellow, cloudy | colourless, clear |
| 13 | yellowish | yellow, cloudy | | |
| 14 | yellowish | yellow, cloudy | yellow, cloudy | colourless, clear |
| 16 | | | | |
| 17 | | | | colourless, clear |

The colour impressions confirmed the results of the ICP-OES analyses. At the beginning of the monitoring period, all samples were colourless and clear. With increasing duration of storage, samples A), B) and C) became cloudy and yellowish, which corresponds to the detachment of adsorber material and the increase in ion concentrations. The colour of sample D) did not change within the monitoring period. The concentration of dissolved ions in sample D) was too low to result in any colour impression.

The method of manufacturing functionalized particles including deviation D), i.e. using a static mixer having a cylindrical design, a length of about 320 mm and an inner diameter of about 11 mm, performed best in the analysis. It was the only method that resulted in stable particles. The method including deviation D) can also be used in case the manufacturing process is further up-scaled. Therefore, this method was used for manufacturing further particles which were then used for phosphate recovery from an aqueous solution. Analyses of phosphate adsorption and desorption characteristics of the particles gave very good results.

Taken together, the inventors established an improved method for the production of more stable ion exchange particles. The attachment of adsorber material on the surface of magnetic carrier particles could be improved in large scale manufacturing (1 kg of ion exchange particles) by optimizing the manufacturing conditions. It was surprisingly found that the selection of a suitable mixing device is crucial for the successful manufacture of stable functionalized particles. In particular, the use of a cylindrical static mixer that has a minimum length and diameter was found to be necessary to obtain stable particles. It could be demonstrated that the functionalized particles obtained by using such a mixer show very low rates of adsorber material release in deionized water. In more saline solutions such as tap water and waste water, even lower release rates should be present, so that the functionalized particles that have been produced the optimized manufacturing method are expected to be stable over several weeks.

1. A method for manufacturing a functionalized magnetic particle, comprising the steps of:
a) mixing an aqueous solution comprising a magnetic microparticle having a silica based surface with an aqueous solution of at least one metal salt to obtain a dispersion, wherein each solution independently has a pH of about 6 to about 8; and
b) mixing the dispersion with a solution of sodium hydroxide for precipitating the metal salt as metal hydroxide and/or metal oxide on the surface of the microparticle, thereby obtaining the functionalized magnetic particle, wherein the mixing is performed by simultaneously pumping the dispersion and the solution of sodium hydroxide through a static mixer, wherein the static mixer has a cylindrical design, a length of at least 320 mm and an inner diameter of at least 11 mm.

2. The method of claim 1, wherein the aqueous solution of the at least one metal salt comprises more than one metal salt, preferably three metal salts, more preferred zinc chloride, iron (III) chloride and zirconyl chloride.

3. The method of claim 1, wherein the static mixer has helical mixer elements.

4. The method of claim 1, wherein a flow rate through the static mixer is about 0.5 to about 4 L/min, preferably about 0.9 to about 2.8 L/min.

5. The method of claim 1, wherein step a) is performed for about 1 to about 5 minutes, preferably for about 5 minutes.

6. The method of claim 1, wherein step b) is performed for about 15 minutes.

7. The method of claim 1, wherein step a) and/or step b) is performed at room temperature, preferably step a) and step b) are performed at room temperature.

8. The method of claim 1, wherein the solution of sodium hydroxide has a sodium hydroxide concentration of about 0.1 to about 0.35 M, preferably of about 0.15 M.

9. The method of claim 1, wherein the dispersion and the solution of sodium hydroxide are mixed in a ratio of about 1:1.

10. The method of claim 1, wherein the method further comprises
c) isolating the functionalized magnetic particle by magnetically separating the particle from the mixture obtained in step b) and removing the supernatant;
d) dispersing the isolated particle in deionized water; and
e) adjusting the pH of the dispersion obtained in step d) to 7.5-8.0, preferably by adding a solution of hydrochloric acid to the dispersion.

11. The method of claim 1, wherein the method further comprises
f) washing the isolated particle with deionized water,
wherein step f) is preferably repeated for at least two times.

12. The method of claim 1, wherein the pumping is performed by means of a peristaltic pump.

13. The method of claim 1, wherein the magnetic microparticle is a soft magnetic or a superparamagnetic microparticle.

14. The method of claim 1, wherein the magnetic microparticle has a diameter of about 5 to about 25 μm, preferably of about 10 to about 15 μm.
